(19) United States
(12) Patent Application Publication
(10) Pub. No.: US 2009/0199813 A1
(43) Pub. Date: Aug. 13, 2009

(54) Premixed Compression Ignition Type Engine And Method Of Controlling Intake Air Thereof

(76) Inventors: Hiroshi Kuzuyama, Aichi (JP); Masahiro Machida, Aichi (JP)

Correspondence Address: Locke Lord Bissell & Liddell LLP;Attn: IP Docketing, Three World Financial Center, New York, NY, 10281-2101, US

(21) Appl. No.: 12/225,046

(22) PCT Filed: Mar. 15, 2007
(86) PCT No.: PCT/JP2007/055250

§ 371 Date: Sep. 11, 2008

(30) Foreign Application Priority Data
Apr. 7, 2006 (JP) 2006-106513

(51) Int. Cl. F02B 1/12; F02B 17/00; F01L 1/34

(52) U.S. Cl. 123/27 R; 123/295; 123/90.15

(57) ABSTRACT

An intake passage (10) including intake ports (4a, 4b, 4c and 4d) connected to combustion chambers (3a, 3b, 3c and 3d) respectively is provided with a mixer (11) producing a mixture by mixing air and a fuel, a throttle valve (12), a bypass passage (16) bypassing the throttle valve (12) and intake manifold (14). The first end (18) of the bypass passage (16) is connected to the intake passage (10) between the mixer (11) and the throttle valve (12). Four second ends (19a to 19d) of the bypass passage (16) are connected to the intake ports (4a, 4b, 4c and 4d) respectively. The bypass passage (16) is provided with an electromagnetic shut off valve (17).

### TECHNICAL FIELD

The present invention relates to a premixed compression ignition type engine and a method of controlling intake air thereof.

### BACKGROUND ART

In recent years, premixed compression self-ignition (homogeneous charge compression ignition (HCCI)) type engines which operate with high efficiency and discharge low amounts of NOx have been drawing attention. Because premixed compression self-ignition (HCCI) combustion enables operation under a leaner mixture than spark ignition (SI) combustion, it has the advantages of increased thermal efficiency and decreased maximum combustion temperature. However, the control of ignition timing is difficult, and despite the use of ignition timing control utilizing internal EGR and so on, the operational range ensuring stable combustion is still limited. Therefore, an engine switching between HCCI combustion and SI combustion in accordance with its operational range has been proposed. An example of such an engine is disclosed in Patent Document 1. Various conditions of HCCI combustion and SI combustion differ, such as the amount of EGR gas and that of the mixture required in the combustion chamber. For example, when switching from SI combustion to HCCI combustion, the amount of gas in the combustion chamber which is composed of the mixture and EGR gas (referred to hereinafter as in-cylinder gas) needs to be increased. On the other hand, the operational range allowing HCCI combustion to be performed stably ranges from an intermediate-rotation intermediate-load side to a low-rotation low-load side. Accordingly, at the time of switching combustion, the throttle valve in the intake passage tends to close, and the pressure is negative in a space from a region downstream of the throttle valve to an intake port located short of each combustion chamber. Therefore, even if the throttle valve is controlled so as to fully open upon switching combustion types, the amount of the mixture supplied to the combustion chamber is insufficient, causing a torque step in the form of a drop in torque.

To solve this problem, Patent Document 1 proposes that upon switching from SI combustion to HCCI combustion in a premixed compression ignition type engine with a supercharger, switching to HCCI combustion is performed only after the conditions for performing HCCI combustion are fulfilled by raising the pressure and temperature in the combustion chamber using the supercharger.

Patent Document 1: JP 2004-176688 A

### DISCLOSURE OF THE INVENTION

### Problem to be Solved by the Invention

However, because a supercharger is an indispensable component of the premixed compression ignition type engine disclosed in Patent Document 1, this proposal does not apply to a premixed compression ignition type engine without a supercharger. Thus, the art of Patent Document 1 has a problem in its inability to offer a solution to an excess or deficiency in the amount of intake mixture caused upon switching between SI combustion and HCCI combustion.

The present invention has been made to solve the above-mentioned problem, and therefore has an object of providing a premixed compression ignition type engine and a method of controlling intake air thereof, such that it is possible to overcome the excess or deficiency in the amount of intake mixture caused upon switching between spark ignition combustion and premixed compression ignition combustion, regardless of the presence or absence of a supercharger.

### Means for Solving the Problems

A premixed compression ignition type engine capable of switching between spark ignition combustion and premixed compression ignition combustion, comprises:

an intake passage communicating with each combustion chamber;

a flow rate adjusting means provided in the intake passage, for controlling a flow rate of an air or a mixture flowing through the intake passage;

a bypass passage bypassing the flow rate adjusting means, the bypass passage having a first end connected to the intake passage upstream of the flow rate adjusting means and a second end connected to the intake passage downstream of the flow rate adjusting means;

a bypass control means opening through or shutting off the bypass passage; and

a control device actuating the bypass control means to open through or shut off the bypass passage upon switching between spark ignition combustion and premixed compression ignition combustion.

A method of controlling intake air of a premixed compression ignition type engine capable of switching between spark ignition combustion and premixed compression ignition combustion, the engine comprising a throttle valve provided in an intake passage, a bypass passage bypassing the throttle valve and an shut off valve provided in the bypass passage, characterized in that

the throttle valve is fully opened and the shut off valve is opened when switching from spark ignition combustion to premixed compression ignition combustion.

### EFFECT OF THE INVENTION

According to the present invention, by comprising: an intake passage communicating with each combustion chamber; a flow rate adjusting means for controlling a flow rate of an air or a mixture flowing through the intake passage; a bypass passage bypassing the flow rate adjusting means; a bypass control means opening through or shutting off the bypass passage; and a control device actuating the bypass control means, because the amount of the mixture sucked into the combustion chamber can be prevented from becoming deficient when switching from premixed compression ignition combustion to spark ignition combustion and the amount of the mixture sucked into the combustion chamber can be prevented from becoming excessive, an excess or a deficiency in the amount of the intake mixture, which is caused upon switching between spark ignition combustion and premixed compression ignition combustion, can be overcome regardless of the presence or absence of a supercharger.

### BRIEF DESCRIPTION OF THE DRAWINGS

FIG. 1 is a diagram showing the construction of a premixed compression ignition type engine according to an embodiment of the present invention;

FIG. 2 is a plan view showing the construction of the intake side of the premixed compression ignition type engine according to the embodiment in detail;

FIG. 3 is a map showing the relationship between a premixed compression ignition combustion range and a spark ignition combustion range;

FIG. 4 is a flowchart for explaining the procedure of switching from spark ignition combustion to premixed compression ignition combustion in the premixed compression ignition type engine according to this embodiment;

FIG. 5 is a diagram showing the opening/closing operation of an electromagnetic shut off valve, the opening/closing operation of a throttle valve, and the state in which an internal EGR is performed or stopped with the passage of time upon switching from spark ignition combustion to premixed compression ignition combustion in the premixed compression ignition type engine according to this embodiment;

FIG. 6 is a flowchart for explaining the procedure of switching from premixed compression ignition combustion to spark ignition combustion in the premixed compression ignition type engine according to this embodiment; and

FIG. 7 is a diagram showing the opening/closing operation of an electromagnetic shut off valve, the opening/closing operation of a throttle valve, and the state in which an internal EGR is performed or stopped with the passage of time upon switching from premixed compression ignition combustion to spark ignition combustion in the premixed compression ignition type engine according to this embodiment.

### BEST MODE FOR CARRYING OUT THE INVENTION

The embodiment of the present invention will be described hereinafter with reference to the accompanying drawings.

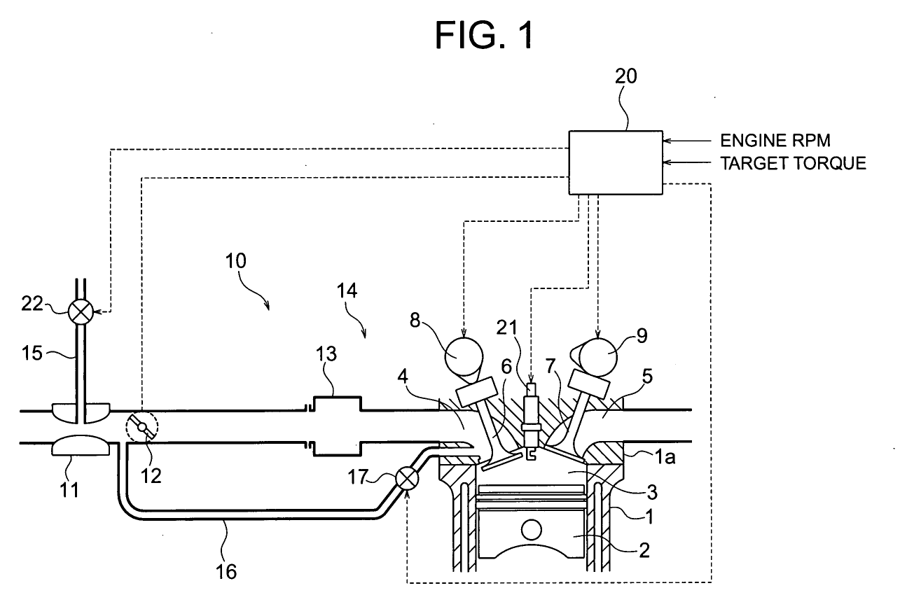

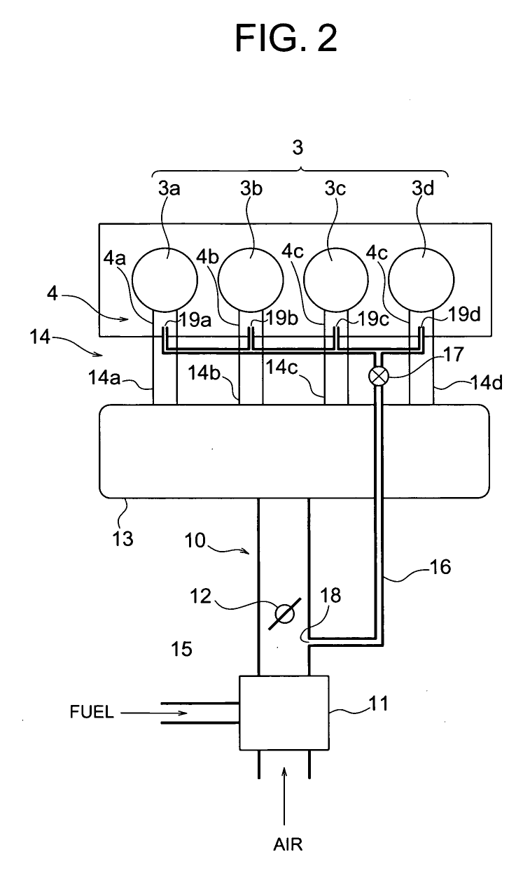

An inline four-cylinder gas engine for a gas heat pump (hereinafter referred to as GHP) will be described as an example of the premixed compression ignition type engine according to this embodiment. As shown in FIG. 1, the premixed compression ignition type engine according to this embodiment comprises: four cylinders 1 (FIG. 1 shows only one cylinder); a piston 2 being vertically movable within the cylinder 1; a combustion chamber 3 formed above the piston 2 within the cylinder 1 defined by the cylinder 1, the piston 2 and a cylinder head 1a; an intake port 4 and an exhaust port 5 formed within the cylinder head 1a and connected to the combustion chamber 3; an intake valve 6 and an exhaust valve 7 bringing the intake port 4 and the exhaust port 5 into or out of communication with the combustion chamber 3 respectively; and an ignition plug 21 disposed so as to penetrate into the combustion chamber 3 from an upper portion of the cylinder head 1a. Cam shafts (not shown) for driving the intake valve 6 and the exhaust valve 7 are provided with known variable valve control mechanisms 8 and 9, respectively. An intake passage 10 including the intake port 4 communicates with the combustion chamber 3. The upstream side of the intake passage 10 is provided with a mixer 11 producing a mixture by mixing air flowing through the intake passage 10 and natural gas, which is a fuel, flowing through a fuel passage 15 and a throttle valve 12 which is a flow rate adjusting means for adjusting the flow rate of the mixture flowing through the intake passage 10. The fuel passage 15 which communicates with the mixer 11 is provided with a fuel flow rate control valve 22. The fuel flow rate control valve 22 controls the flow rate of city or municipal gas which is a gaseous fuel, and cooperates with a throttle valve 12 to control the air-fuel ratio of the mixture. An intake manifold 14 including a surge tank 13 is provided downstream of the throttle valve 12. After the mixture flows into the surge tank 13, the mixture is supplied to the intake port 4 through each of branch tubes 14a to 14d (see FIG. 2). Furthermore, the intake passage 10 is provided with a bypass passage 16 bypassing the throttle valve 12, and the bypass passage 16 is provided with a quick response type electromagnetic shut off valve 17 which is a bypass control means. In addition, the premixed compression ignition type engine according to this embodiment is also provided with an ECU 20 which is a control device. The variable valve control mechanisms 8 and 9, the throttle valve 12, the electromagnetic shut off valve 17, the ignition plug 21, and the fuel flow rate control valve 22 are electrically connected to the ECU 20.

FIG. 2 shows the construction of the intake side of the premixed compression ignition type engine according to the embodiment in detail. The combustion chamber 3 consists of four combustion chambers 3a, 3b, 3c and 3d which are in each of the four cylinders, and the intake port 4 consists of intake ports 4a, 4b, 4c and 4d which are connected to the combustion chambers 3a to 3d respectively. Furthermore, the intake manifold 14 consists of the surge tank 13 and the branch tubes 14a, 14b, 14c and 14d which are connected to the surge tank 13 at one end and to the intake ports 4a to 4d at the other end respectively. A first end 18 which is one end of the bypass passage 16 is connected to the intake passage 10 between the mixer 11 and the throttle valve 12. The other end of the bypass passage 16 consists of four second ends 19a, 19b, 19c and 19d which the other end branches off, the second ends 19a to 19d are connected to the intake ports 4a to 4d respectively. In the bypass passage 16, the electromagnetic shut off valve 17 is provided in a position which is nearer the second ends 19a to 19d than the first end 18.

Next, the operation of the premixed compression ignition type engine according to this embodiment will be described.

When the premixed compression ignition type engine according to this embodiment is started, the air flowing through the intake passage 10 and the natural gas flowing through the fuel passage 15 are mixed with each other in the mixer 11 to become the mixture, as shown in FIG. 2. After the flow rate of the mixture is adjusted by the throttle valve 12, the mixture flows through the intake passage 10 and into the surge tank 13 of the intake manifold 14. The mixture having flowed into the surge tank 13 is divided among the branch tubes 14a to 14d, and sucked in the combustion chambers 3a to 3d through the intake ports 4a to 4d when the intake valve 6 is opened. The mixture in the combustion chamber 3 is compressed by the piston 2, ignited at a suitable time by the ignition plug 21 to combust. Exhaust gas produced after combustion is discharged to the exhaust port 5 when the exhaust valve 7 is opened.

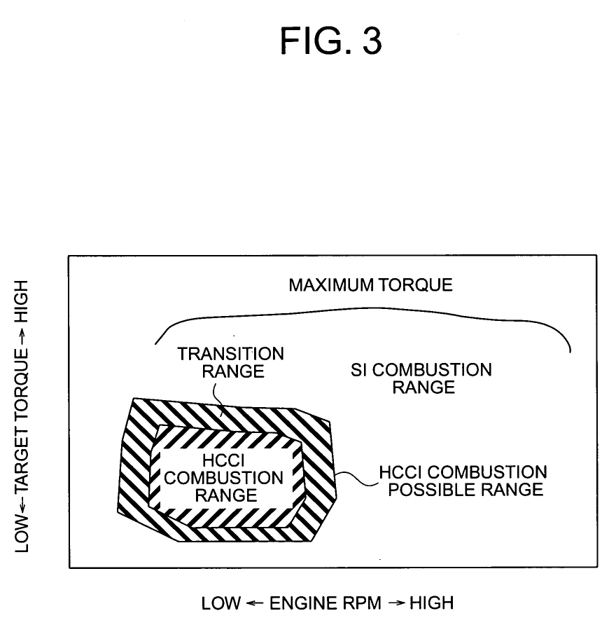

In general, spark ignition (SI) combustion as described above is performed when starting the premixed compression ignition type engine. In the premixed compression ignition (HCCI) combustion according to this embodiment, ignition timing control is performed by controlling the temperature of the gas in the combustion chamber 3 while also making use of a later-described internal EGR. Thus, because the temperature of the engine greatly influences the ignition control, until the warm-up process is completed and the temperature of the engine is stabilized, the engine is under an operational condition that makes it substantially difficult to perform HCCI combustion. A map as shown in FIG. 3, which represents the relationship between SI combustion range and a premixed compression ignition (HCCI) combustion range, is incorporated in the ECU 20. When starting the premixed compression ignition type engine, the engine is not usually under the condition of the HCCI combustion range. In other words, because the state of operation which is expressed by engine rotational speed and engine torque is not suited for HCCI combustion, the ECU 20 determines that the engine is under the conditions for SI combustion and actuates the ignition plug 21. After that, the ECU 20 receives signals indicating the rotational speed of the gas engine, the target torque, and so on. When the ECU 20 determines that the engine is under the conditions for HCCI combustion, the ECU 20 stops the operation of the ignition plug 21 to perform HCCI combustion operation. In the map of this embodiment shown in FIG. 3, for convenience of control, a transition range is provided between the HCCI combustion range and the SI combustion range. The transition range is provided so as to surround the outer limit of the HCCI combustion range within a range in which HCCI combustion can be performed (HCCI combustion possible range). The reason for providing the transition range will be described later. The HCCI combustion possible range in which suitable combustion and suitable control can be performed without causing any inconveniences such as premature ignition or knocking even when HCCI combustion is performed, is provided in the range in which HCCI combustion can be performed. For this reason, the range in which HCCI combustion can be performed differs depending on each set of conditions prerequisite for the gas engine for the premixed compression ignition type engine, such as the kind of fuel and the characteristics of the variable valve control mechanisms. The map shown in FIG. 3 is no more than an example in this embodiment.

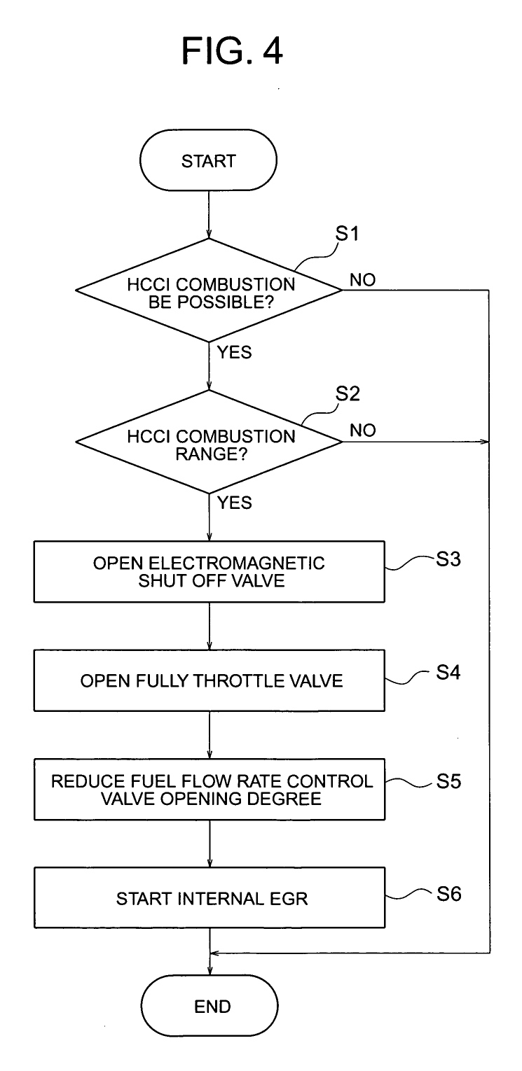

Next, the procedure for switching from SI combustion to HCCI combustion in the premixed compression ignition type engine according to this embodiment will be described on the basis of the flowchart in FIG. 4.

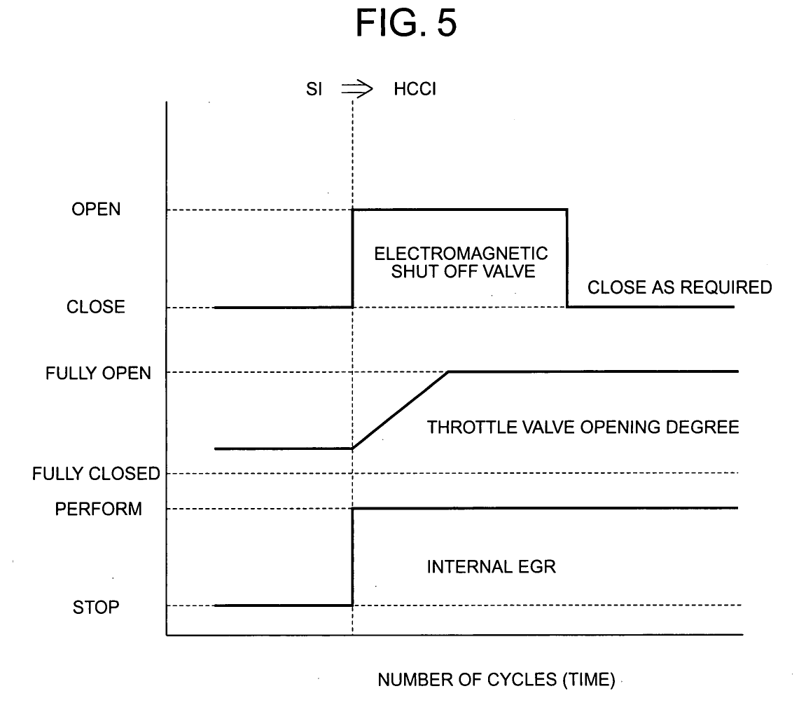

In the case where SI combustion is performed in the premixed compression ignition type engine, the ECU 20 periodically determines whether HCCI combustion can be performed or not based on the operational range of the premixed compression ignition type engine and the operational condition thereof. If HCCI combustion can be performed, the operation switches to HCCI combustion. When this process is started, it is first determined whether the premixed compression ignition type engine has been warmed up to allow HCCI combustion or not (step S1). More specifically, a detection means (not shown) is used to detect the coolant temperature and oil temperature of the premixed compression ignition type engine. If one of the coolant or oil temperatures is lower than a preset threshold, it is determined that the current state of the engine is not suited for HCCI combustion, and the above-mentioned process is terminated. On the other hand, if both the coolant temperature and the oil temperature of the premixed compression ignition type engine are higher than the threshold, a determination on the range of operation is performed in order to determine whether HCCI combustion can be performed or not. More specifically, the ECU 20 determines whether the state of operation is within the HCCI combustion range or not (step S2) based on the map shown in FIG. 3. If it is determined that the state of operation is not within the HCCI combustion range, the present process is terminated. On the other hand, if it is determined that the state of operation is within the HCCI combustion range, the ECU 20 opens the electromagnetic shut off valve 17 to open through the bypass passage 16 (step S3). Because the electromagnetic shut off valve 17 is a quick response type solenoid valve, it instantaneously opens after receiving a signal from the ECU 20. At the same time, the ECU 20 fully opens the throttle valve 12 (step S4). However, because the opening/closing operation of a throttle valve 12 is slower than that of the electromagnetic shut off valve 17 due to the difference between their constructions, it looks like the opening degree of the throttle valve 12 gradually increases after the electromagnetic shut off valve 17 is opened. The ECU 20 changes the air-fuel ratio of the mixture to the lean side by reducing the degree of opening of the fuel flow rate control valve 22 (step S5) concurrently with opening the electromagnetic shut off valve 17. This control is performed to prevent a torque step from being created after taking into account the fact that HCCI combustion is higher in thermal efficiency than SI combustion. After the control regarding the amount and air-fuel ratio of the mixture is performed as described in the above, the ECU 20 controls the variable valve control mechanisms 8 and 9 to advance the timing for closing the exhaust valve 7 with respect to top dead center and retard the timing for opening the intake valve 25 with respect to top dead center, thereby performing the control of so-called negative overlap (step S6). That is, a portion of the exhaust gas is retained in the combustion chamber 3 (internal EGR) by closing the exhaust valve 7 in the course of an exhaust stroke. The procedure for switching is terminated as described above. Note that, FIG. 5 shows the operation of opening/closing the electromagnetic shut off valve 17, the operation of opening/closing the throttle valve 12, and the state in which internal EGR is performed or stopped with the passage of time.

Because the mixture sucked into the combustion chamber is mixed with the high-temperature burned gas retaining in the combustion chamber by internal EGR, the temperature of the gas in the combustion chamber rises. Thus, because the temperature in the combustion chamber 3 in the vicinity of compression top dead center also increases, compression self-ignition occurs stably.

Conventionally, the mixture sucked into the combustion chamber 3 may become deficient immediately after switching to HCCI combustion. By realizing negative overlap for internal EGR, the period in which the mixture can be sucked into the combustion chamber in an intake stroke changes, and the variable valve control mechanism substantially serves to control the amount of the mixture entering the combustion chamber as well. Because the amount of the in-cylinder gas needs to be greater during HCCI combustion than during SI combustion, the throttle valve 12 is fully opened to compensate for excessive deficiency in the mixture. However, because the HCCI combustion range is between a low-rotation low-load range and an intermediate-rotation intermediate-load range and the degree of opening of the throttle valve 12 is low before switching combustion, the pressure downstream of the throttle valve 12 is less than or equal to atmospheric pressure (a negative pressure). Furthermore, the condition where the pressure in the intake port 4 is temporarily less than or equal to atmospheric pressure (a negative pressure) is not overcome and the amount of the mixture sucked into the combustion chamber 3 may become deficient because the operation of opening/closing the throttle valve 12 is slow due to the characteristics of an actuator. However, because the mixture flows through the bypass passage 16 and into the intake port 4 without being reduced in pressure by the throttle valve 12, the state of the negative pressure in the intake port 4 is swiftly overcome, and the amount of the mixture sucked into the combustion chamber 3 is prevented from becoming deficient. Thus, a reduction in torque is prevented.

After switching from SI combustion to HCCI combustion according to the above-mentioned procedure, if HCCI combustion continues and is then stabilized, the ECU 20 closes the electromagnetic shut off valve 17 as required. After that, if the condition of operation is within the HCCI combustion range, HCCI combustion is continued. If the state of operation fluctuates within the HCCI combustion range, HCCI combustion can be stably continued by controlling the variable valve control mechanisms 8 and 9 to change the amount of internal EGR or adjusting the degree of opening of the fuel flow rate control valve 22. If the condition of operation shifts to the SI combustion range, the ECU 20 switches to SI combustion for actuating the ignition plug at compression top dead center or at a suitable timing before or after compression top dead center. More specifically, when the state of operation shifts from inside the transition range to the transition range within the HCCI combustion possible range, switching to SI combustion is performed. If the switching is performed after the state of operation shifts outside of the HCCI combustion possible range, the performance of control may be too late to prevent inconveniences such as engine stalling and so on. To avoid such inconveniences, the transition range is provided outside the HCCI combustion range within the HCCI combustion possible range. Thus, the width of the transition range is determined such that the operational state of the gas engine for the GHP shifts from the HCCI combustion range to the SI combustion range without detecting that it is in the transition range.

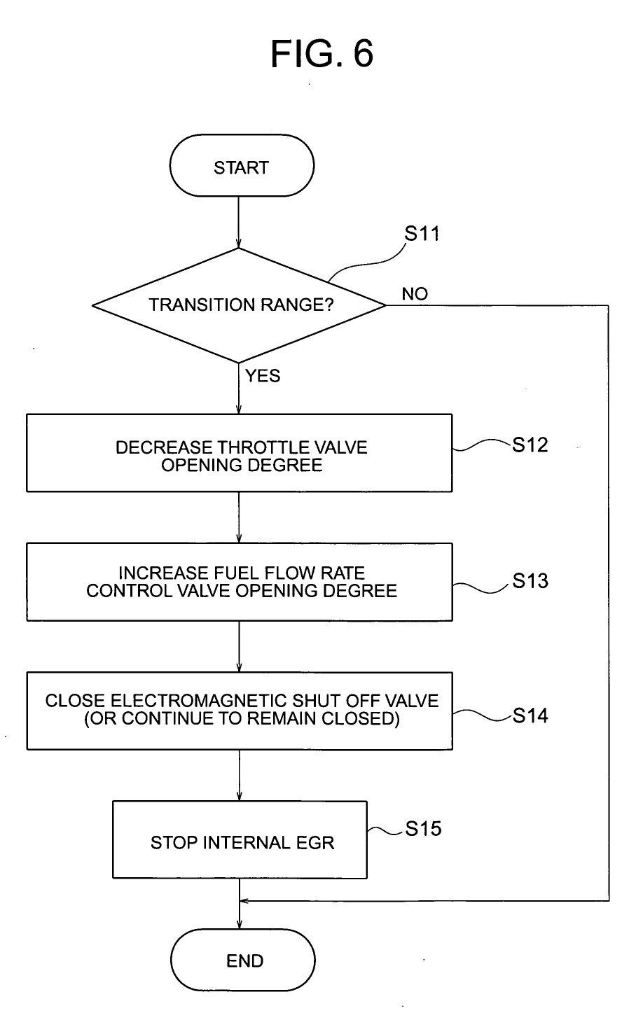

Next, the procedure for switching from HCCI combustion to SI combustion in the premixed compression ignition type engine according to this embodiment will be described on the basis of the flowchart in FIG. 6.

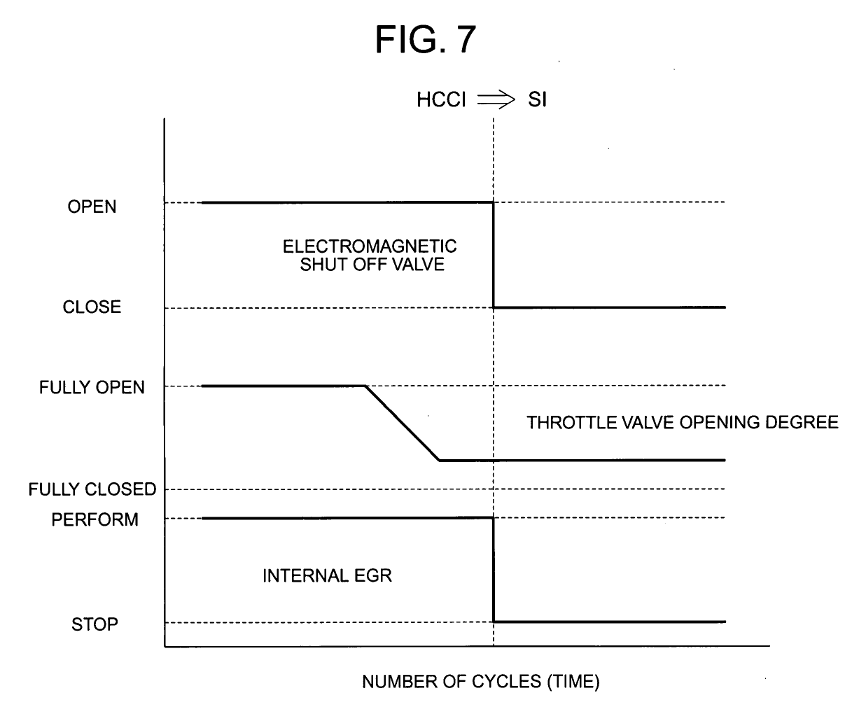

In the case where HCCI combustion is performed in the premixed compression ignition type engine, the ECU 20 periodically determines whether shifting to SI combustion should be performed or not based on the range of operation and the condition of operation. If shifting to SI combustion is likely to occur based on the shifting of the state of operation to the transition range, switching to SI combustion is performed. When this process is started, it is determined whether the condition of operation is within the transition range or not based on the map shown in FIG. 3 (step S11). If it is determined that the condition of operation is not within the transition range, HCCI combustion is continued and the above-mentioned process is terminated. On the other hand, if it is determined that the condition of operation is within the transition range, the ECU 20 reduces the degree of opening of the throttle valve 12 to an opening degree appropriate to the amount of the mixture at the time of SI combustion. That is, the ECU 20 establishes a state in which the throttle valve 12 adjusts the flow rate of the mixture to a suitable flow rate in advance (step S12). The ECU 20 also acts as a control to increase the degree of opening of the fuel flow rate control valve 22, thereby changing the air-fuel ratio to the rich side so that the air-fuel ratio becomes suited for SI combustion (step S13). After the operation of reducing the degree of opening of the throttle valve 12 and the changing in the air-fuel ratio are terminated, the ECU 20 closes the electromagnetic shut off valve 17 to shut off the bypass passage 16 (step S14). At this point in time, when the electromagnetic shut off valve 17 closes, it continues to remain closed. Subsequently the ECU 20 controls the variable valve control mechanisms 8 and 9 so as to cancel the state of negative overlap. In other words, the ECU 20 stops internal EGR and changes the timing of the opening/closing valves and the cylinder valve lift to those for SI combustion (step S15). The procedure for switching is terminated as described in the above. FIG. 7 shows the operation of opening/closing the electromagnetic shut off valve 17, the operation of opening/closing the throttle valve 12, and the state in which internal EGR is performed or stopped with the passage of time.

When switching to SI combustion with fully opening the throttle valve 12, because the difference between the pressures in the intake port 14 and the combustion chamber 3 increases due to the stop of internal EGR, the mixture whose amount is more than or equal to the amount which is required in SI combustion is sucked into the combustion chamber 3 temporarily. As a result, a torque step may be caused so as to increase the torque. However, because the electromagnetic shut off valve 17 is closed after the throttle valve 12 is adjusted to the appropriate degree of opening and the internal EGR is stopped so as to switch to SI combustion after the state controlling the amount of the mixture upon SI combustion is implemented, the amount of the mixture sucked into the combustion chamber 3 is prevented from temporarily becoming excessive. As a result, a rise in torque is prevented.

As described above, because the bypass passage 16 bypassing the throttle valve 12 controlling the flow rate of the mixture and the electromagnetic shut off valve 17 provided in the bypass passage 16 are provided, where the ECU 20 fully opens the throttle valve 12 and opens the electromagnetic shut off valve 17, the mixture flows through the bypass passage 16 and into the intake port 4 without being reduced in pressure by the throttle valve 12, thus overcoming the negative pressure in the intake port 4 temporarily and preventing the sucked mixture from becoming deficient. Furthermore, when switching from HCCI combustion to SI combustion, the ECU 20 closes the electromagnetic shut off valve 17 so as to implement the state controlling the amount of the mixture upon SI combustion after reducing the degree of opening of the throttle valve 12 to an appropriate degree, and then the internal EGR is stopped so as to switch to SI combustion. Thus, an excess of the amount of the sucked mixture, which may occur temporarily, can be prevented. That is to say, an excess or a deficiency in the amount of the intake mixture which is caused upon switching between SI combustion and HCCI combustion can be overcome.

In this embodiment, the mixer 11 producing a mixture by mixing air and fuel is provided upstream of the throttle valve 12, and the mixture is made to flow through the bypass passage 16. However, the present invention is not limited to this construction. A fuel injection nozzle may be provided downstream of the throttle valve 12. In this case, the throttle valve 12 controls the flow rate of air flowing through the intake passage 10 and air that is not reduced in pressure by the throttle valve 12 flows into the intake port 4. The feed rate of fuel injected from the fuel injection nozzle is controlled so as to become the predetermined air-fuel ratio based on the air feed rate detected by means for detecting the amount of air such as an air flow meter (not shown) and so on disposed in the intake passage 10. An engine having such a construction also can provide the same effect as that provided by the embodiment by controlling the feed rate of fuel with the feed rate of air flowing through both the intake passage 10 and bypass passage 16.

In this embodiment, the electromagnetic shut off valve 17 is provided in a position in the bypass passage 16, which is nearer the second ends 19a to 19d than the first end 18. The position is preferably as near the combustion chambers 3a to 3d as possible. Because the mixture without being reduced in pressure by the throttle valve 12 reaches right before the upstream side of the electromagnetic shut off valve 17 in the bypass passage 16, the mixture can be supplied to the vicinity of the combustion chambers 3a to 3d as early as possible after the electromagnetic shut off valve 17 opens without being reduced in pressure by the throttle valve 12 if the electromagnetic shut off valve 17 is provided as near the combustion chambers 3a to 3d as possible. Accordingly, the effects provided by this embodiment can be improved.

In this embodiment, the second ends 19a to 19d of the bypass passage 16 are connected to the intake ports 4a to 4d. However, the present invention is not limited to this construction. They may be connected to any other portions which are downstream of the surge tank 13.

In this embodiment, city or municipal gas is used as fuel. However, the present invention is not limited thereto. Any gaseous fuel such as natural gas can be used.

In this embodiment, the premixed compression ignition type engine is described by referring to a gas engine for a GHP as an example. However, the present invention is not limited thereto. The premixed compression ignition type engine may also be a diesel engine using light oil as a fuel or a gasoline engine. The premixed compression ignition type engine is not limited to the inline four-cylinder engine. However, it may be any type of engine.

In this embodiment, the throttle valve fully opens and the internal EGR is performed upon HCCI combustion. However, the present invention is not limited to this construction. Upon HCCI combustion, because of self-ignition, the temperature and pressure in the combustion chamber must be higher than those upon SI combustion in the vicinity of top dead center of a compression stroke or right before ignition. In this embodiment, as means for realizing this, only controlling the full opening of the throttle valve and the internal EGR are performed. If, for example, any ignition conditions required for HCCI combustion as described the above are obtained, the full opening of the throttle valve may not always be necessary to be performed when controlling the throttle valve upon switching from SI combustion to HCCI combustion.

1. A premixed compression ignition type engine capable of switching between spark ignition combustion and premixed compression ignition combustion, characterized in that the engine comprises:
an intake passage communicating with each combustion chamber;
a flow rate adjusting means provided in the intake passage, for controlling a flow rate of an air or a mixture flowing through the intake passage;
a bypass passage bypassing the flow rate adjusting means, the bypass passage having a first end connected to the intake passage upstream of the flow rate adjusting means and a second end connected to the intake passage downstream of the flow rate adjusting means;
a bypass control means opening through or shutting off the bypass passage; and
a control device actuating the bypass control means to open through or shut off the bypass passage upon switching between spark ignition combustion and premixed compression ignition combustion.

2. The premixed compression ignition type engine according to claim 1, characterized in that the intake passage comprises an intake port communicating with each combustion chamber and a second end is connected to each intake port.

3. The premixed compression ignition type engine according to claim 1, characterized in that the intake passage comprises a surge tank and an intake manifold downstream of the flow rate adjusting means and each second end is connected to the intake passage downstream of the surge tank.

4. The premixed compression ignition type engine according to claim 1, characterized in that the bypass control means is an electromagnetic shut off valve.

5. The premixed compression ignition type engine according to claim 1, characterized in that the bypass control means is provided in a position which is nearer the a second end than the first end.

6. A method of controlling intake air of a premixed compression ignition type engine capable of switching between spark ignition combustion and premixed compression ignition combustion, the engine comprising a throttle valve provided in an intake passage, a bypass passage bypassing the throttle valve and an shut off valve provided in the bypass passage, characterized in that
the throttle valve is fully opened and the shut off valve is opened when switching from spark ignition combustion to premixed compression ignition combustion.
